(19) United States
(12) Patent Application Publication
(10) Pub. No.: US 2005/0015677 A1
(43) Pub. Date: Jan. 20, 2005

(54) Method of executing a computer program

(76) Inventors: Hans-Frederick Brown, Montreal (CA); Sylvio Drouin, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/836,621

(22) Filed: May 3, 2004

Related U.S. Application Data
(60) Provisional application No. 60/466,792, filed on May 1, 2003.

(30) Foreign Application Priority Data
May 1, 2003 (CA) 2,427,697

(51) Int. Cl. H02H 3/05

(52) U.S. Cl. 714/38

(57) ABSTRACT

The present invention relates to a method of of controlling an execution of an object-oriented computer program comprising a plurality of programming objects, comprising: detecting at least one data transmission between two of the plurality of programming objects; identifying at least one of said at least one data transmission as an invalid data transmission; and executing at least two of the plurality of programming objects according to the detecting and the identifying, wherein the invalid data transmission is not performed. The present invention also provides a method of executing an object-oriented computer program from a specified state, comprising: recording a plurality of state parameter values defining a plurality of states of the program at a plurality of intervals while executing the program; reviewing at least one of the plurality of states; identifying one of the plurality of states as a state of interest according to the reviewing; and executing the program from the state of interest according to a corresponding at least one of the state parameter values.

The present application claims priority of U.S. provisional application 60/466,792 filed May 1, 2003.

### BACKGROUND OF THE INVENTION

(a) Field of the Invention

The invention relates generally to executing computer programs and more particularly to executing computer programs according to user-defined parameters.

(b) Description of Prior Art

Software testing and debugging is gradually becoming time-consuming as applications are being designed to handle increasingly complex tasks. The term “testing” is generally known in the industry to designate the process according to which errors are detected, and “debugging”, the process according to which a cause for a detected error is identified.

Traditional debugging methods are laborious, and generally involve following the flow of a program line-by-line and inserting print statements at particular locations so that variables and the like may be checked to determine whether their values correspond to expectations. In order to facilitate the debugging process, computer programs called “debuggers” have been created.

A debugger is generally a tool that aids software development by giving a programmer control over, and access to information about a running application program. It typically runs as a self-contained process, controlling the program under study through operating system primitives specifically designed for that purpose. One of the features usually provided by debuggers is known as “single-stepping”, and involves executing only one program instruction at a time. Another equally useful feature consists in displaying a content of computer registers and memory locations. A third common feature consists in setting breakpoints at particular locations, whereby a program is executed until the breakpoint is reached.

U.S. Pat. No. 5,021,948, titled “Program counter display device” describes a method of providing a program counter mark showing program flow and control structure in correspondence with the program list. Although the method is useful for recognizing a flow and structure of a program, it does not provide means for accessing other variables defining its run-time states.

U.S. Pat. No. 4,734,854, titled “System for generating software source code components”, describes a system for designing and developing generic programming modules, which may be reused in different applications, and within different operational contexts. Although the disclosed invention is useful for reducing inadvertent errors in a program, it does not provide means for disabling modules and/or specific data flows thereof, whereby an efficiency with which programs are tested, debugged, and understood would be significantly improved.

U.S. Pat. No. 4,595,981, titled “Method of testing interfaces between computer program modules”, discloses a method of designing cause/effect charts for each module comprised in a program, and test interfaces between the modules by executing cases specified in the charts. Although the disclosed method is useful for monitoring variables passed between modules, it does not provide means for conveniently disabling a flow of variables between modules, whereby an effect of each exchanged variable on a receiving module would be readily identifiable.

U.S. Pat. No. 5,124,989, titled “Method of debugging a computer program”, describes a method of storing and exploiting a history of common debugging commands executed on a program in order to facilitate ensuing detection and correction of errors comprised therein. Although the disclosed method is useful for the purpose of establishing a combination of debugging commands deemed useful in a specific programming context, the debugging commands themselves are common.

### SUMMARY OF THE INVENTION

It would be desirable to be provided with a method for conveniently disabling a data flow between programming objects comprised in a computer program, whereby the data flow would not be performed during an execution of the program, in order to test a functionality of a receiving programming object, or evaluate an effect of the data flow on the object.

It would also be desirable to be provided with a method of storing a plurality of programming states encountered during a cyclical execution process of a program, and providing means to perform a cyclical execution of the program from a specified one of the plurality of encountered states, whereby a programmer would be able to efficiently gather information related to a cycle of interest.

In accordance with the present invention, there is provided a method of controlling an execution of an object-oriented computer program comprising a plurality of programming objects, comprising: detecting at least one data transmission between two of the plurality of programming objects; identifying at least one of the at least one data transmission as an invalid data transmission; and executing at least two of the plurality of programming objects according to the detecting and the identifying, wherein the invalid data transmission is not performed.

In accordance with one embodiment of the invention, the identifying comprises a user specifying the invalid data transmission.

In accordance with one embodiment of the invention, the method further comprises displaying a list of the at least one data transmission, wherein the identifying comprises a user selecting the invalid data transmission from the list.

In accordance with one embodiment of the invention, the method further comprises identifying at least one of the plurality of programming objects as an inactive programming object, wherein the inactive programming object is not executed.

In accordance with one embodiment of the invention, the method further comprises displaying a list of the plurality of programming objects, wherein the identifying at least one of the plurality of programming objects comprises selecting the at least one inactive programming object from the list.

In accordance with one embodiment of the invention, the identifying at least one of the at least one data transmission as an invalid data transmission comprises determining whether one of the at least one data transmission involves one of the at least one inactive programming object.

In accordance with the present invention, there is provided a computer program product for controlling an execution of an object-oriented computer program comprising a plurality of programming objects comprising a computer usable storage medium having computer readable program code means embodied in the medium, the computer readable program code means comprising: computer readable program code means for detecting at least one data transmission between two of the plurality of programming objects; computer readable program code means for identifying one of the at least one data transmission as an invalid data transmission; and computer readable program code means for executing at least two of the plurality of programming objects according to the detecting and the identifying, wherein the invalid data transmission is not performed.

In accordance with the present invention, there is provided a method of executing a computer program from a specified state, comprising: executing the program; recording a plurality of states of the program at a plurality of intervals during the executing, wherein each of the plurality of states is defined by a plurality of state parameter values; identifying one of the plurality of states as a state of interest; and executing the program from the state of interest.

In accordance with one embodiment of the invention, the method further comprises displaying a state line, displaying a slider, associating each of a plurality of positions on the state line to one of the plurality of states, wherein the identifying comprises moving the slider along the state line to a position of interest corresponding to the state of interest.

In accordance with one embodiment of the invention, the method further comprises displaying a plurality of reference points on the state line, wherein each of the plurality of reference points indicates one of the plurality of positions.

In accordance with one embodiment of the invention, the position of interest is located between two of the plurality of reference points, and the providing a state of interest comprises interpolating two states associated with the two of the plurality of reference points.

In accordance with one embodiment of the invention, the method further comprises specifying interpolation parameters, wherein the interpolating is performed according to the interpolation parameters.

In accordance with the present invention, the method further comprises moving the slider along the state line according to the executing, whereby the slider indicates a position on the state line corresponding to a current state of the program.

In accordance with one embodiment of the invention, the method further comprises displaying at least one state parameter.

In accordance with one embodiment of the invention, the method further comprises identifying at least one state parameter of interest, and displaying the at least one state parameter of interest.

In accordance with one embodiment of the invention, the method further comprises specifying a state parameter value of interest, and interrupting the executing the program from the state of interest when the value of interest is obtained.

In accordance with one embodiment of the invention, the identifying comprises specifying one of the plurality of intervals corresponding to the state of interest.

In accordance with the present invention, there is provided a computer program product for executing a computer program from a specified state comprising a computer usable storage medium having computer readable program code means embodied in the medium, the computer readable program code means comprising: computer readable program code means for recording a plurality of state parameter values defining a plurality of states of said program at a plurality of intervals while executing said program; computer readable program code means for recording a plurality of states of said program at a plurality of intervals during said executing, wherein each of said plurality of states is defined by a plurality of state parameter values; computer readable code means for reviewing at least one of said plurality of states; computer readable program code means for identifying one of said plurality of state intervals as a state of interest; and computer readable program code means for executing said program from said state of interest according to a corresponding at least one of said state parameter values.

### BRIEF DESCRIPTION OF THE DRAWINGS

FIG. 1 illustrates a first view of a data flow node-link structure representing a computer program, as well as a second view of results obtained through an execution of the program;

FIG. 2 illustrates a hierarchical node-link structure representing the program, as well as lists of data flows associated to nodes representing relevant objects;

FIG. 3 illustrates the hierarchical node-link structure, as well as lists of data sources associated to nodes representing relevant objects;

FIG. 4 illustrates the first view of the data flow node-link structure, as well as the second view of results, wherein two data flows have been added;

FIG. 5 illustrates the hierarchical node-link structure, as well as the lists of data flows, wherein the lists take into consideration the additional data flows;

FIG. 6 illustrates the hierarchical node-link structure, as well as the lists of data sources, wherein the lists take into consideration the additional data flows;

FIG. 7 illustrates the first view of the data flow node-link structure, as well as the second view of results, wherein a data flow is disabled;

FIG. 8 illustrates the hierarchical node-link structure, as well as the lists of data flows, wherein the lists take into consideration the disabled state of the data flow;

FIG. 9 illustrates the hierarchical node-link structure, as well as the lists of data sources, wherein the lists take into consideration the disabled state of the data flow;

FIG. 10 illustrates the first view of the data flow node-link structure, and the second view of results, wherein a programming object is disabled;

FIG. 11 illustrates the hierarchical node-link structure, as well as the lists of data sources, wherein the lists take into consideration the disabled state of the object;

FIG. 12 illustrates the first view of the data flow node-link structure, and the second view of results, wherein a parent object is disabled;

FIG. 13 illustrates the hierarchical node-link structure, as well as the lists of data flows, wherein the lists take into consideration the disabled state of the parent object;

FIG. 14 illustrates the hierarchical node-link structure, as well as the lists of data sources, wherein the lists take into consideration the disabled state of the parent object;

FIG. 15 illustrates a state line controller comprising a slider indicating that a computer program is starting its initial cycle, and a state view presenting initial values of selected state variables;

FIG. 16 illustrates the state line controller and the state view, wherein the values of the selected state variables result from a 4^{th} executed cycle, and the counter indicates that the program is starting a 5^{th} cycle;

FIG. 17 illustrates the state line controller and the state view, wherein the values of the selected state variables result from a 5^{th} executed cycle, and the counter indicates that the program is starting a 6^{th} cycle;

FIG. 18 illustrates the state line controller and the state view, wherein the values of the state variables result from a 6^{th} executed cycle, and the counter indicates that the program is starting a 7^{th} cycle;

FIG. 19 illustrates the state line controller and the state view, wherein the slider is moved from a graduation designating a 7^{th} cycle to another one designating a 5^{th} cycle, and the values of the state variables correspond to a last 5^{th} cycle executed;

FIG. 20 illustrates the state line controller and the state view, wherein a value of one of the state variables is specified as resulting from a 4^{th} cycle executed;

FIG. 21 illustrates the state line controller and the state view, wherein the slider is positioned by the programmer such that it refers to an 8^{th} cycle, and default values are assigned to the state variables since the 7^{th} cycle has never been completely executed; and

FIG. 22 illustrates the state line controller and the state view, wherein the slider is positioned between graduations designating a 6^{th} and 7^{th} cycle, and the values of the state variables are assigned by interpolation.

### DETAILED DESCRIPTION OF THE INVENTION

In object-oriented computer programming, two debugging approaches have been traditionally taken.

The first approach favours creative flows, and consists in writing the entire program without performing any tests, wherein programmers may fully concentrate on creating objects and data flows. It is only after the program is entirely created that it is tested and debugged. Such an approach involves a time-consuming debugging process, as inadvertent errors may be scattered across the program. In order to determine the cause of a located error, relevant objects are isolated, and tested, individually and in combination with others. In the context of textual programming, the isolation process usually involves commenting out all lines of the program involving irrelevant objects, whether they are comprised within relevant or irrelevant objects. Alternatively, the process may consist in inserting and setting flags, such that irrelevant objects and associated data transmissions are not executed.

The second approach is more conservative, and consists in testing programming objects as they are created. The time spent on debugging is greatly reduced as a scope of a search performed to locate a cause of a detected error is constrained to objects being tested. However, such an approach disturbs a flow with which objects are created, as each creation of an object is followed by a corresponding testing and debugging process.

Although an efficiency of the two approaches has been improved with the advent of sophisticated debuggers, their weaknesses are sustained by the growing complexity of computer programs. The present invention provides a method for testing and debugging programs combining the advantages of both approaches.

The present invention is described in the context of a program implementing a genetic algorithm designed to find the sequence of letters of the alphabet. When executed, the program generates two sequences of 26 letters, assigns to each sequence a score based on how similar it is to the sequence of the alphabet, and stores the one with the highest score in a pool of solutions along with their score. The process may be repeated until a created sequence of letters obtains a score indicating a perfect match with the sequence of the alphabet.

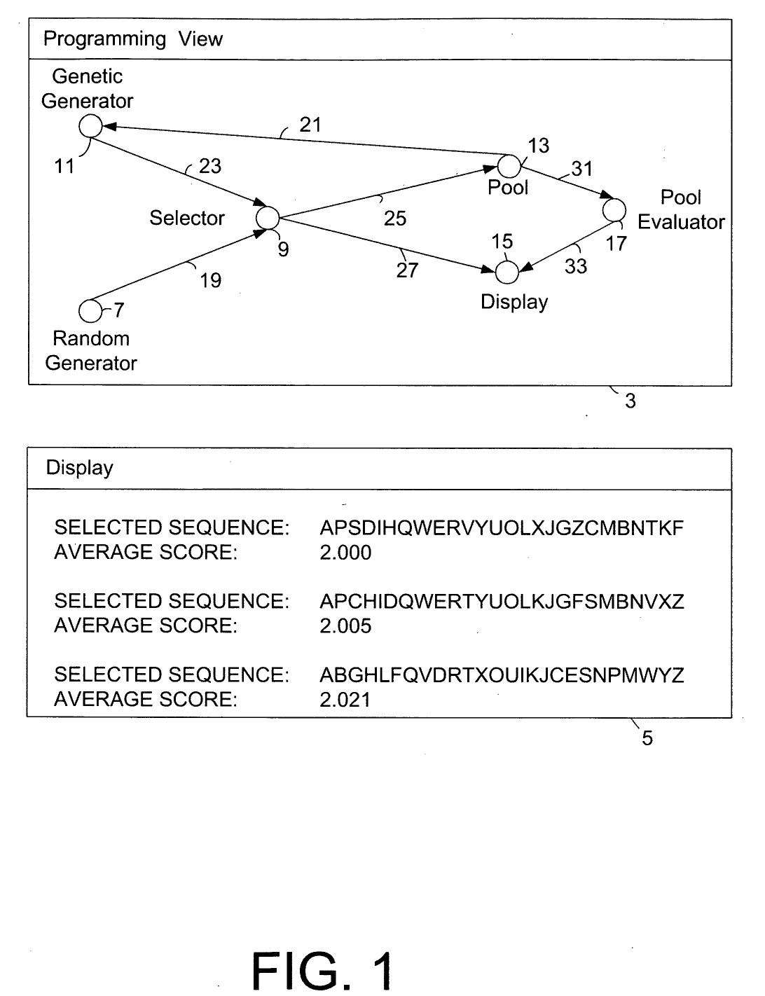

FIG. 1 illustrates a first view 3 of a data flow node-link structure representing the program, and a second view 5 of results obtained through an execution of the program.

In the view 3, there are shown six labelled nodes, each of which represents an object of the program, and sever links, each of which represents a data flows between two corresponding objects. In the following description, labels shall be taken to designate underlying objects.

A node 7 labelled “Random Generator” represents an object responsible for randomly generating sequences of 26 letters from a list of the 26 letters of the alphabet, and providing them to an object represented by a node 9, labelled “Selector”. A link 19 represents the flow of randomly generated sequences from the Random Generator to the Selector.

A node 11 labelled “Genetic Generator” represents an object responsible for generating sequences of letters by applying genetic operators on sequences stored in an object represented by a node 13 labelled “Pool”. Two operators are implemented:
a) A mutation, for which it selects one of existing sequences, and replaces some of its letters by random ones.
b) A crossbreeding, for which it selects two of existing sequences and randomly selects a first letter of either one of the two as a first letter of a new sequence, a second letter of either one of the two, as the second letter, and so on, until all 26 letters of the new sequence are selected.

Once the sequences are generated, they are sent to the Selector. A link 21 represents the flow of existing sequences from the Pool to the Genetic Generator. Another link 23 represents the flow of the genetically generated sequence from the Genetic Generator to the Selector.

The Selector is an object responsible for retrieving a randomly generated sequence and a genetically generated one, assigning a score to each one of the two sequences, selecting one of the two as having a higher score, and providing the selected one along with its score to the Pool. The selected sequence is also sent to a programming object represented by a node 15, labelled “Display”. A score represents a number of matching letters between a corresponding sequence, and that of the alphabet. A Link 25 represents the flow of the selected sequence and its score from the Selector to the Pool, and a link 27, that of the selected sequence from the Selector to the Display.

The Pool is an object responsible for storing the selected sequence of letters and its score retrieved from the Selector.

The Display is an object responsible for displaying the selected sequence and its score, received from the Selector, and an average score of the sequences stored in the Pool, retrieved from an object represented by a node 17 labelled “Pool Evaluator”.

The Pool Evaluator is an object responsible for retrieving all scores stored in the Pool, and calculating their average in order for the latter to be provided to the Display. A link 31 represents the flow of scores from the Pool to the Pool Evaluator. Another link 33 represents the flow of the average score from the Pool Evaluator to the Display.

In the following description, two programming objects are said to have a hierarchical relation when one of the two calls the other. The calling object is known as “the parent” of the called object, and the latter, “a child” of the calling object. Furthermore, each object of a program has one parent and one parent only, except for an object embodying a reference to the program. It is also important to note that a parent may have more than one child.

According to the present invention, each parent is associated to a list comprising data flows, or data transmissions, involving one of its children at the receiving end. More specifically, for each one of those data flows, the list comprises a corresponding data flow state, a pointer to a corresponding source, as well as an identifier of an involved child. In the preferred embodiment, a data flow state indicates whether a corresponding data flow is disabled.

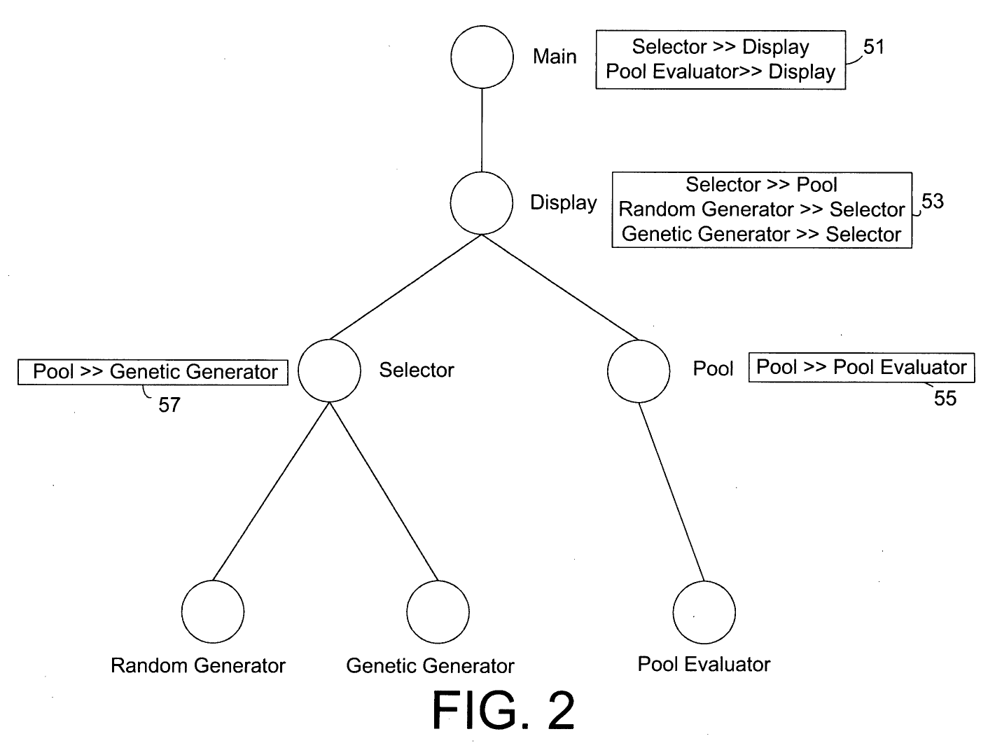

FIG. 2 illustrates a hierarchical node-link structure representing the program, as well as lists of data flows associated to nodes representing relevant objects. Each object comprised in the program is represented by a labelled node, and each hierarchical relation between objects is represented by a link between corresponding nodes.

The Main embodies a pointer to the program, and has one child, the Display. The latter has two children, the Selector and the Pool. The Selector also has two children, the Random Generator and the Genetic Generator, whereas the Pool has only one child, namely the Pool Evaluator. The Random Generator, Genetic Generator, and Pool Evaluator are not considered parents since they do not have children.

The Main is associated to a list 51 of all data flows involving its child, namely the Display, at the receiving end. More specifically, the list 51 is comprised of the data flows originating from the Selector and Pool Evaluator, and destined for the Display. The latter is associated to a list 53 of all data flows involving either one of the Selector and the Pool at the receiving end. More specifically, the list 53 is comprised of the data flow originating from the Random Generator and Genetic Generator, and destined for the Selector, as well as that originating from the latter and destined for the Pool. As for the Selector, it is associated to a list 57 of all data flows involving the Genetic Generator at the receiving end. More specifically, the list 57 is comprised of the data flow originating from the Pool and destined for the Genetic Generator. Finally, the Pool is associated to a list 55 of all data flows involving the Pool Evaluator at the receiving end, namely the one originating from the Pool.

As for the Selector, it is not associated to such a list since none of its children, namely the Random Generator and Genetic Generator, is involved at a receiving end of a data flow. Finally, the Random Generator, Genetic Generator, and Pool Evaluator are not associated to such lists, as they are not considered parents.

According to the present invention, when an object embodying a reference to a program is executed, a recursive process is initiated, whereby each called parent establishes a list of data sources for each one of its enabled children, and calls the latter sequentially in order for them to be executed. If a called object is not a parent, it processes its list of data sources in order to retrieve data from other objects, and performs its main function accordingly.

A first object may need to retrieve data from a second object that has not yet been called. In such a case, the first object calls the second object, which will retrieve its list of data sources, and execute itself. Once the second object has been executed, the first retrieves the data it needs, and resumes its own execution. In the preferred embodiment, in order for objects to be able to determine which ones have been called, each called object is required to set a call flag accessible to all others.

Once all enabled children of a same parent are executed, the latter resumes its execution by processing its own list of data sources, and performing its main function. The execution of the program ends when an object embodying a reference to the program has been executed.

A parent establishes a list of data sources for an enabled child by searching through its own list of data flows for enabled data flows originating from an enabled source and destined for the corresponding child, locating such data flows, and incorporating pointers to their sources in a list. In the preferred embodiment, the parent sends the list to the child immediately after calling it.

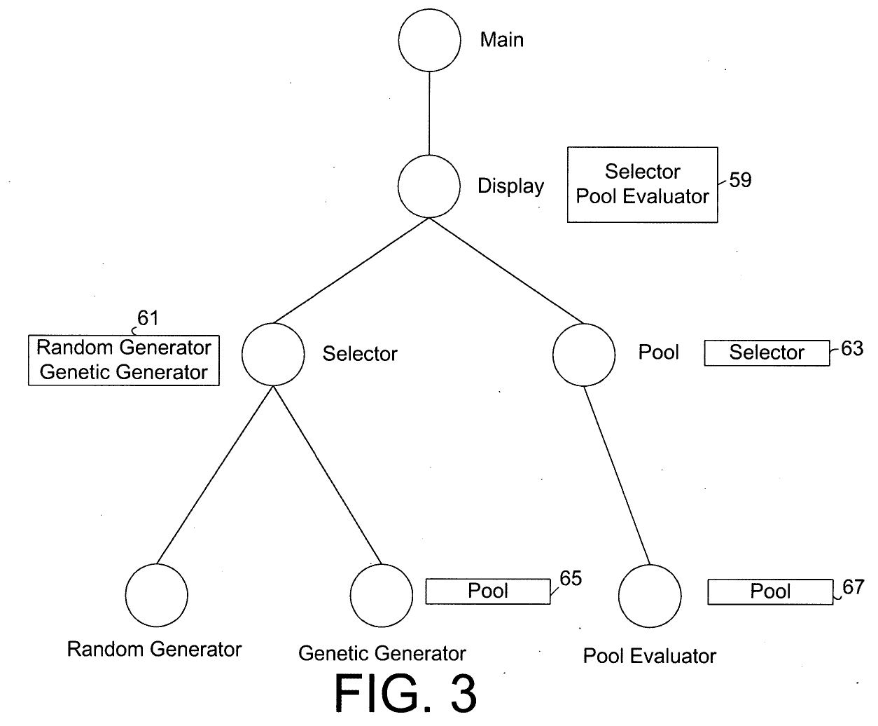

FIG. 3 illustrates the hierarchical node-link structure representing the program, as well as lists of data sources associated to nodes representing relevant objects.

According to the present invention, when the Main, which embodies the reference to the program, is called, it establishes a list of data sources 59 for the Display, according to its own list of data flows 51. The list 59 is comprised of pointers to each data source of the Display, namely the Selector and Pool Evaluator. Subsequently, the Main calls the Display.

When the Display is called, it establishes a list of data sources 61 for the Selector and another list 63 for the Pool, according to its own list of data flows 53. The list 61 is comprised of pointers to each data source of the Selector, namely the Random Generator and Genetic Generator. As for the list 63, it is comprised of a pointer to the data source of the Pool, namely the Selector. Subsequently, the Display calls the Selector.

When the Selector is called, it establishes a list of data sources 65 for the Genetic Generator according to its own list of data flows 57. The list 65 is comprised of a pointer to the data source of the Genetic Generator, namely the Pool. Subsequently, the Selector calls the Random Generator. It is important to note that the Selector does not need to establish a list of data sources for the Random Generator since the latter is not comprised in its list of data flows 57 as a receiving object.

The Random Generator does not have any children, and therefore, does not need to establish lists of data sources. Furthermore, it is not provided with a list of data sources, and therefore, does not need to retrieve data from other objects in order to perform its tasks. As a result, when the Random Generator is called, it simply executes itself. Subsequently, the Selector calls its other child, the Genetic Generator.

The Genetic Generator does not have any children, and therefore, does not need to establish lists of data sources. When called, it processes its list 65 in order to retrieve a sequence of letters from the Pool, accesses the call flag of the Pool and is informed that the latter has not been called. Consequently, the Genetic Generator calls the Pool, which retrieves its list of data sources 63 from the Display, establishes a list of data sources 67 for the Pool Evaluator according to its own list of data flows 55, and calls the latter object.

The Pool Evaluator does not have any children, and therefore, does not need to establish lists of data sources. When called, it processes its list 67 in order to retrieve scores from the Pool. The Pool Evaluator accesses the call flag of the Pool to determine whether the latter has been called. Since the Pool has already been called, the Pool Evaluator retrieves the scores, and calculates their average.

When the execution of the Pool Evaluator is completed, the Pool resumes its execution by processing its own list of data sources 63. The Pool is informed that the Selector has already been called by accessing its call flag, and as a result, it retrieves and stores the selected sequence of letters along with its score.

Once the execution of the Pool is completed, the Genetic Generator retrieves the at least one sequence of letters on which it will apply a genetic operator in order to generate a new sequence of letters. Subsequently, the Selector resumes its execution since the Random Generator and Genetic Generator have both been executed. The Selector processes its list of data sources 61 to retrieve the sequences of letters generated by the Random Generator and Genetic Generator, verifies that the latter have been called by accessing their call flag, retrieves their sequences, attributes a score to each sequence, and selects the one with the highest score.

Since the Selector and Pool have both been executed, the Display resumes its own execution by processing its list of data sources 59, verifying that the Pool Evaluator and Selector have been called by accessing their call flag, retrieving the average score of the sequences stored in the Pool from the Pool Evaluator, as well as the selected sequence and its score from the Selector, and displaying the retrieved data within the view 5.

The program ends with the display of the selected sequence and the average score of the sequences stored in the Pool. It is important to note that in the case illustrated in FIG. 1, the program has been executed several times since several selected sequences and several scores are displayed within the view 5.

During a debugging process, programmers typically modify a program and monitor an effect of their modifications in order to locate a cause of a located error. A modification might consist in removing or adding a data flow, which translates, in the context of visual programming interfaces, into removing or adding a corresponding link.

In the preferred embodiment, a programmer adds such a link by invoking a data flow structure editing mode through a control button or a displayed icon, moving the mouse pointer over a corresponding source node, pressing on the left button of the mouse to identify the node as being the source, moving the mouse pointer over a corresponding destination node, and pressing on the left button of the mouse to identify the node as being the destination.

According to the present invention, when such modifications are detected, all lists of data flows are updated in order for the program to be executed accordingly. In the preferred embodiment, and in the case where the modification consists in adding a data flow, each node identified as a new source or destination during the editing process is stored, and following each identification of a destination, a previously identified source is retrieved and a combination of the source and the destination is defined as an additional data flow to an existing data flow structure. When an additional data flow is defined, a corresponding update of all data flow lists is invoked.

In another embodiment, the programmer adds such a link by invoking a display of a data flow editing panel, in which the programmer specifies, for each data flow that he wishes to add, the names of a corresponding source and destination. When all additional data flows have been defined, the programmer invokes an update of all data flow lists through a control button or a displayed icon.

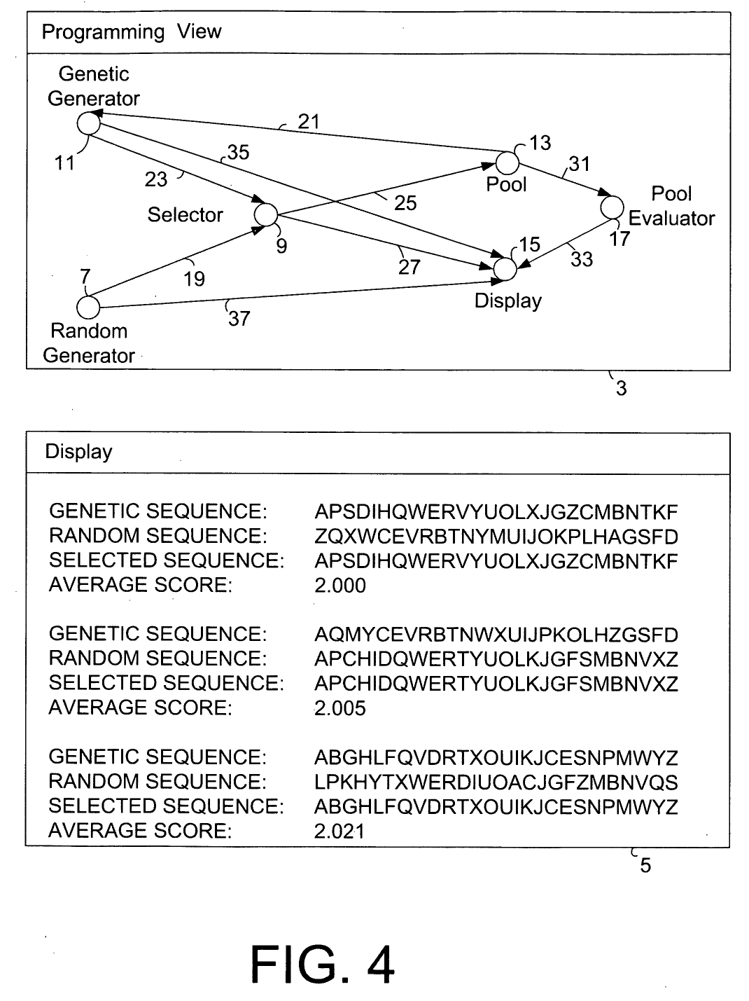

FIG. 4 illustrates the first view 3 of the data flow node-link structure, and the second view 5 of the results, wherein two data flows have been added.

In order to contemplate generated sequences, the programmer added two data flows originating from the Genetic Generator and Random Generator, and destined for the Display. The additional data flows are represented within the view 3 by links 35 and 37.

As a result of these modifications, the generated sequences of letters are displayed within the view 3, alongside selected sequences and average scores of the sequences stored in the Pool. In order to achieve such a display, the lists of data sources are automatically updated when modifications regarding the data flow structure of the program are detected.

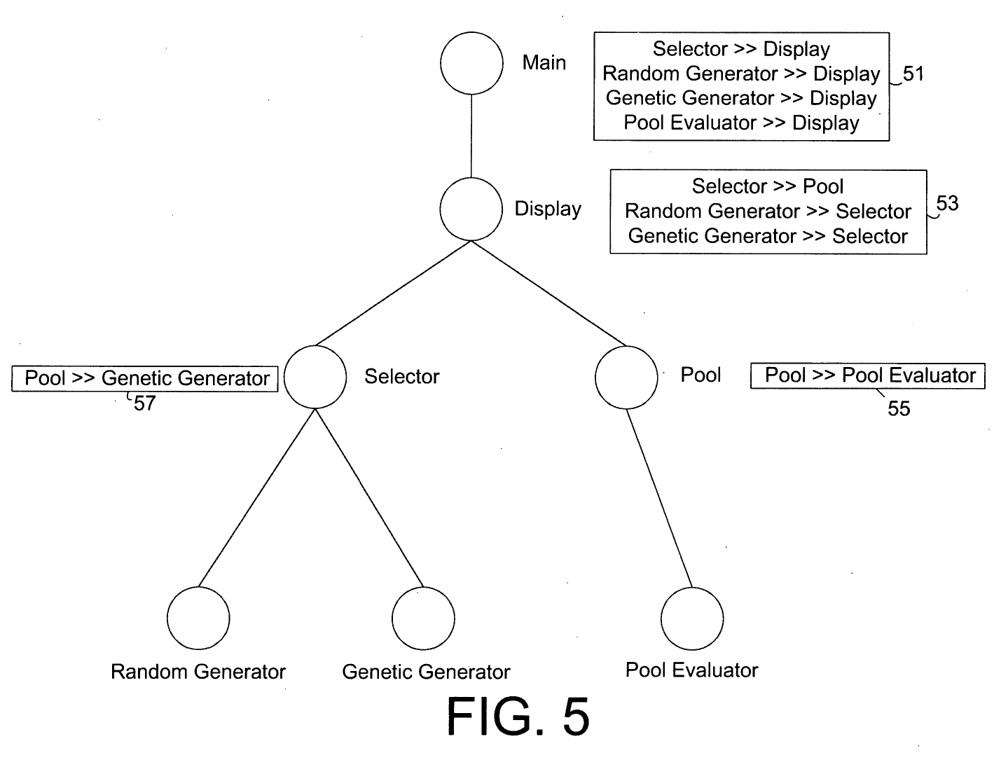

FIG. 5 illustrates the hierarchical node-link structure, as well as the lists of data flows, wherein the lists take into consideration the additional data flows.

When the additional data flows are detected, they are automatically incorporated in the list 51, since they are both destined for the Display, which is a child of the Main. As for the other lists, they are not modified since the additional data flows do not involve a child of a corresponding object at the receiving end. However, the modifications of the lists of data flows are propagated through the lists of data sources.

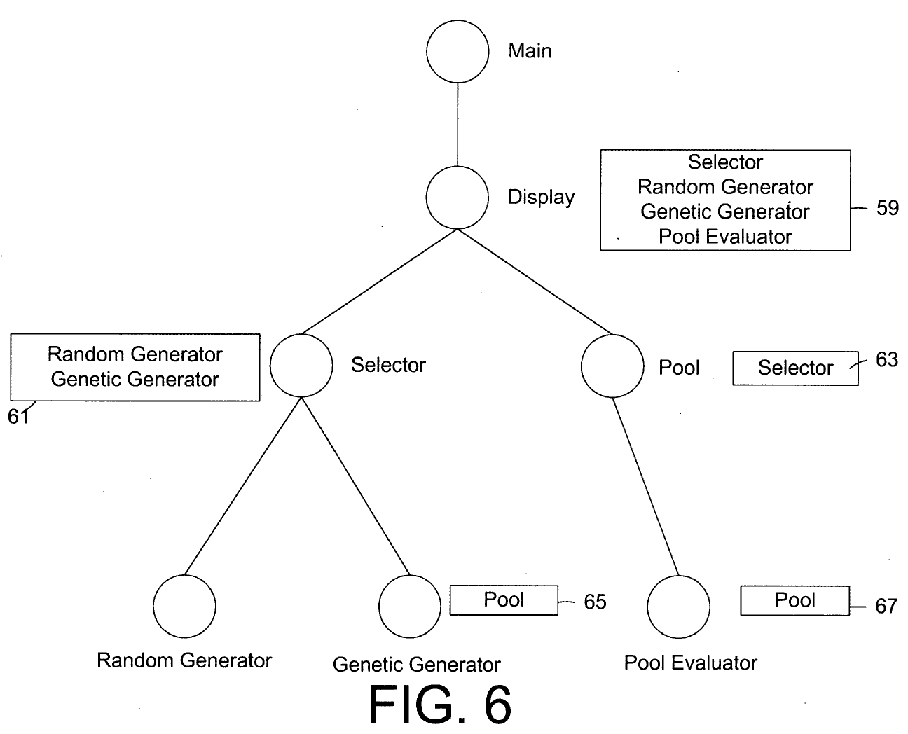

FIG. 6 illustrates the hierarchical node-link structure, as well as the lists of data sources, wherein the lists take into consideration the additional data flows.

The list of data sources 59 established by the Main for the Display diverges from the one illustrated in FIG. 3 as two new sources are added: the Random Generator and Genetic Generator. As a result, when the Display resumes its execution, it retrieves sequences from the Genetic Generator and Random Generator in addition to the selected sequence and average score retrieved from the Selector and Pool Evaluator respectively, and displays the retrieved data within the view 3, as illustrated in FIG. 4.

In another embodiment, the programmer, prior to executing the program, invokes a code generation engine, which examines a single list of all data flows, searches through the program to identify those that are not implemented, and implements them by inserting corresponding lines of code in the program. The resulting version of the program is saved as a new file, and executed, wherein the execution takes into consideration the additional data flows.

During a debugging process, programmers often remove existing data flows in order to isolate a receiving object. According to the present invention, the programmer may disable an existing data flow without having it removed, nor commenting out corresponding lines in the program. Furthermore, the programmer does not need to restore the data flow nor comment in corresponding lines of code the data flow when he wishes for it to occur. Instead, he may enable the data flow, and request that the program be executed accordingly. It is important to note that according to the present invention, when adding or removing a data flow, the program is not modified and does not need to be recompiled before execution. However, when commenting in or out lines of code, the source code is modified and the resulting version of the program must be recompiled before execution.

In the preferred embodiment, the process of enabling and disabling a data flow is performed within the view 3, by having the programmer select corresponding links through a mouse pointer. However, in another embodiment, the programmer is provided with a list of data flows, wherein each entry in the list comprises a data flow source, a data flow destination, as well as a checkbox, and the user may enable or disable data flows by checking corresponding checkboxes.

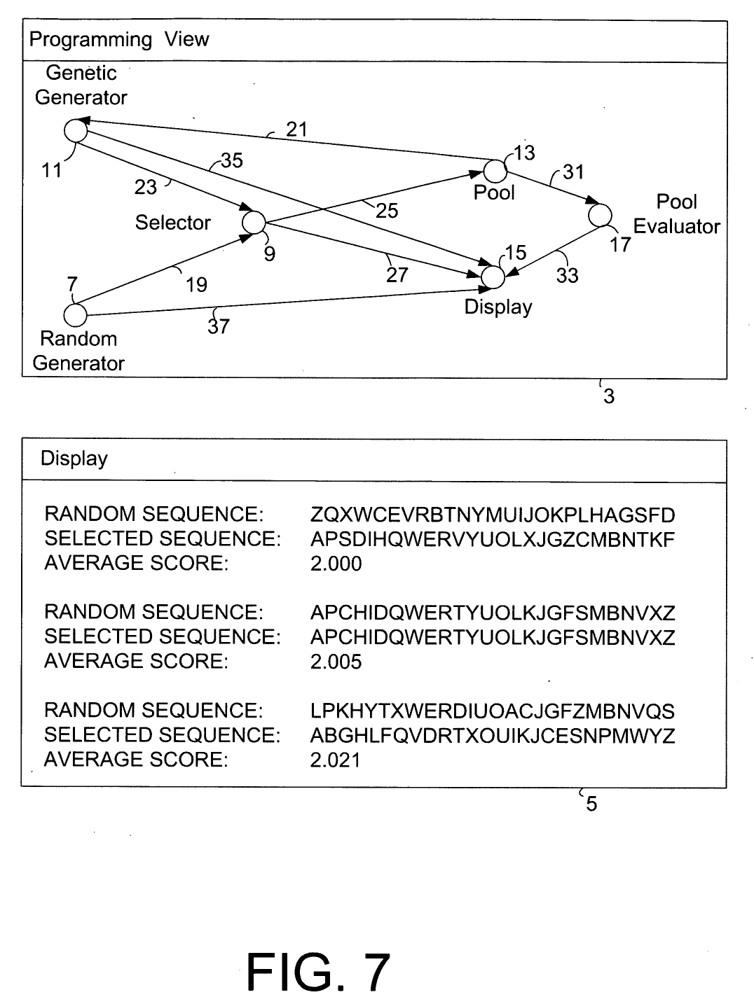

FIG. 7 illustrates the first view 3 of the data flow node-link structure, and the second view 5 of the results, wherein a data flow is disabled.

In order to concentrate on randomly generated sequences, the programmer disabled the data flow between the Genetic Generator and the Display by selecting the link 35 within the view 3. As a result, genetically generated sequences are not presented within the view 5, since they are no longer retrieved by the Display.

According to the present invention, once a new data flow state is detected, the lists of data flows are modified accordingly. A new data flow state may result from the enabling of a disabled data flow, or the disabling of an enabled data flow.

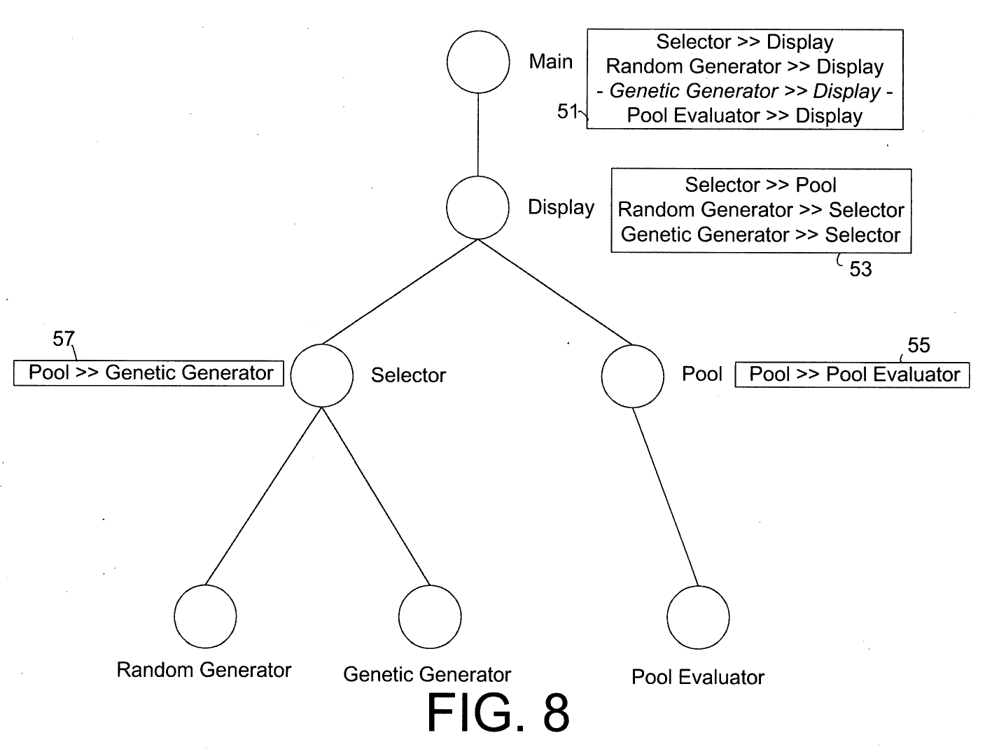

FIG. 8 illustrates the hierarchical node-link structure as well as the lists of data flows, wherein the lists take into consideration the disabled state of the data flow. More specifically, the state of the data flow between the Genetic Generator and the Display is modified in the list 51 associated to the Main. The other lists are not affected by the modification as they do not comprise the disabled data flow. However, the modification propagates through the lists of data sources established by the Main.

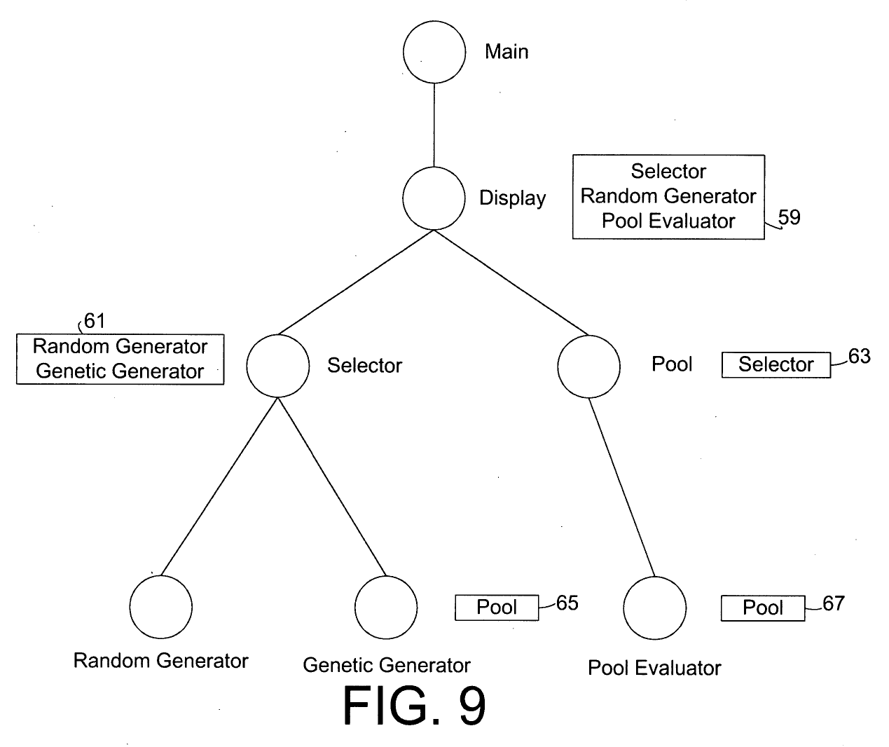

FIG. 9 illustrates the hierarchical node-link structure as well as the lists of data sources, wherein the lists take into consideration the disabled state of the data flow. When the list 59 is established by the Main for the Display, the data flow between the Genetic Generator and the Display is ignored since it is disabled. Consequently, the Genetic Generator is not comprised in the list 59 as a data source for the Display, and the sequence it provides is not presented to the programmer within the view 5 since it is not retrieved by the Display.

As mentioned previously, a programmer may isolate an object by disabling one or several related data flows. However, an output of the isolated object may not be clearly identifiable, as it may be affected by an execution of other objects. According to the present invention, objects deemed useless or obtrusive to the debugging of another may be disabled, whereby an output of the object being debugged may be clearly identified. In the preferred embodiment, objects are enabled or disabled through the view 3, by having the programmer select corresponding nodes through a mouse pointer. In another embodiment, the programmer is provided with a list of objects, wherein a checkbox is associated to each object, and the user selects those objects he wishes to disable by checking corresponding checkboxes.

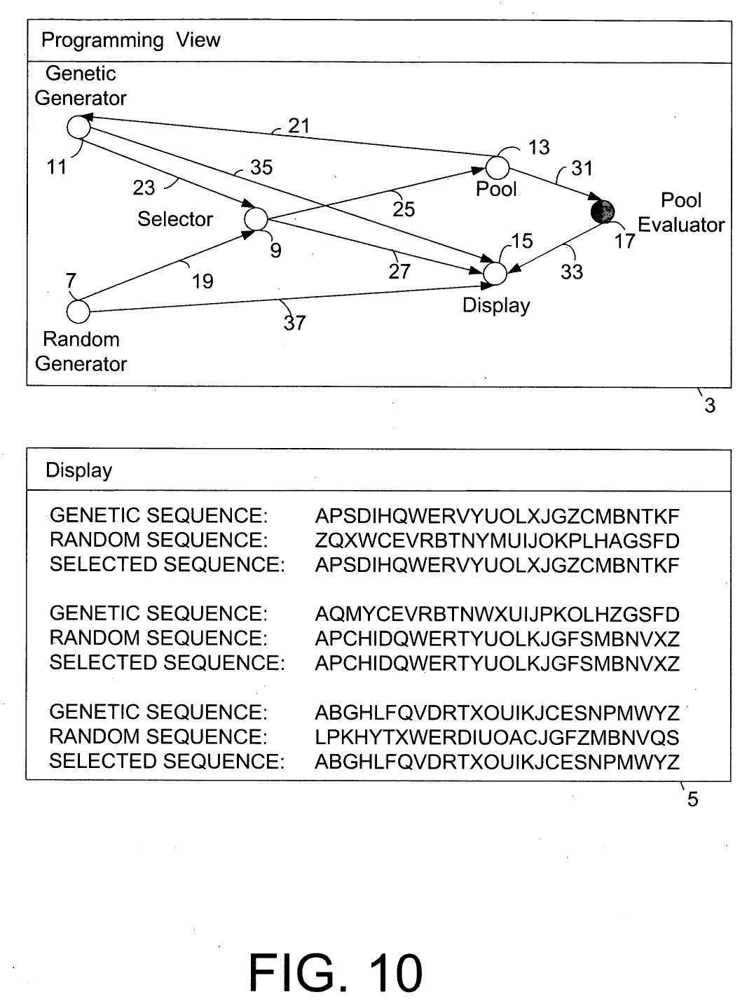

FIG. 10 illustrates the first view 3 of the data flow node-link structure, and the second view 5 of the results, wherein an object is disabled, namely the Pool Evaluator.

In order to debug a combination of objects including the Genetic Generator, Random Generator, and Selector, the programmer disabled the Pool Evaluator, thereby preventing its lengthy execution, as well as the cumbersome display of average scores. Although the Pool and Display are not comprised in the combination, they are not disabled, as their execution is deemed useful for the debugging process. The Pool is relevant for the functionality of the Genetic Generator as it provides the latter with existing sequences. As for the Display, it provides means for outputs of the three target objects to be presented within the view 5.

According to the present invention, each object comprises a state flag indicating a corresponding state, and accessible to all other objects. When new object states are detected, the state flags of corresponding objects are updated accordingly. In the preferred embodiment, an object may either be enabled or disabled. As such, a new object state results either from the enabling of a disabled object, or the disabling of an enabled object.

Although a modification of a state of an object does not affect the lists of data flows, it propagates through the lists of data sources, since the latter are only established for, and comprised of, enabled objects.

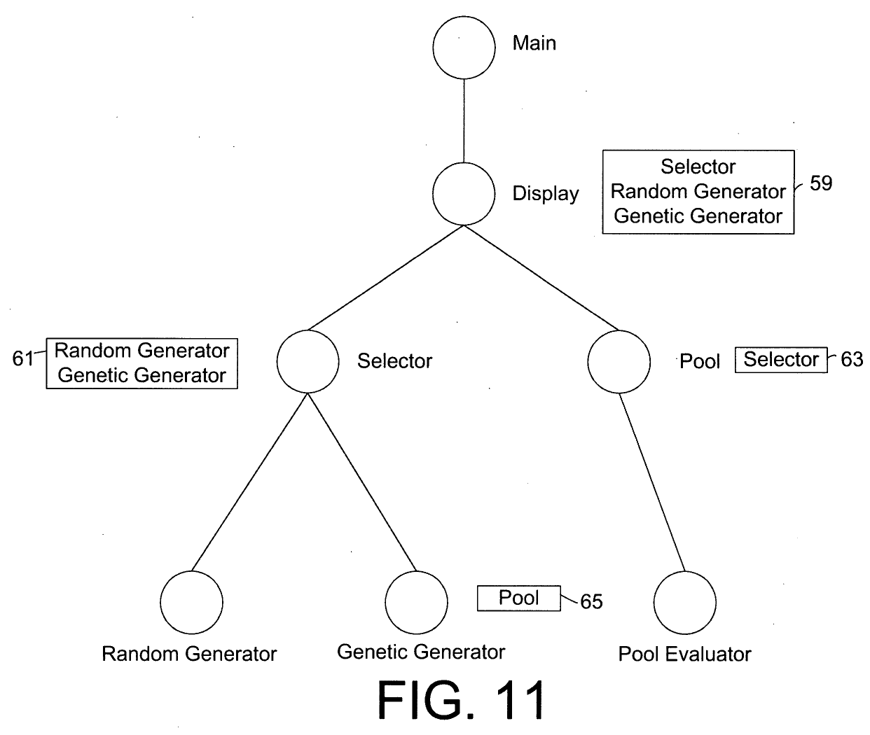

FIG. 11 illustrates the hierarchical node-link structure as well as the lists of data sources, wherein the lists take into consideration the disabled state of the Pool Evaluator.

A first repercussion of the disabled state of the Pool Evaluator is the exclusion of the latter from the lists of data sources. When establishing the list of data sources 59 for the Display, the Main verifies whether the corresponding sources are enabled by accessing their state flag. The Selector, Random Generator, and Genetic Generator are enabled, and are consequently included in the list 59. However, the Pool Evaluator is disabled, and is therefore not included. As a result, average scores are not retrieved by the Display and may not be presented within the view 5, as illustrated in FIG. 10.

A second, lesser, repercussion relates to the list of data sources of the Pool Evaluator. Prior to establishing such a list, the Pool verifies whether the Pool Evaluator is disabled by accessing its state flag. Since the Pool Evaluator is disabled, the Pool does not establish the list.

In another embodiment, the programmer, prior to executing the program, invokes a code generation engine, which examines a single list of all objects comprised in the program, wherein the list specifies which of those objects are disabled. Subsequently, the engine comments out all lines of code implementing a call to, or a data flow involving one of the disabled objects. Once all corresponding lines have been commented out, the resulting version of the program is saved as a new file, and executed, wherein the execution ignores the disabled objects.

In the case illustrated in FIGS. 10 and 11, the disabled object, namely the Pool Evaluator, is not a parent. As a result, its disabled state does not have any repercussions on a child that it would otherwise have. According to the present invention, if a disabled object is a parent, its at least one child is not executed, but preserves its state, and consequently, may still be considered as an enabled data source.

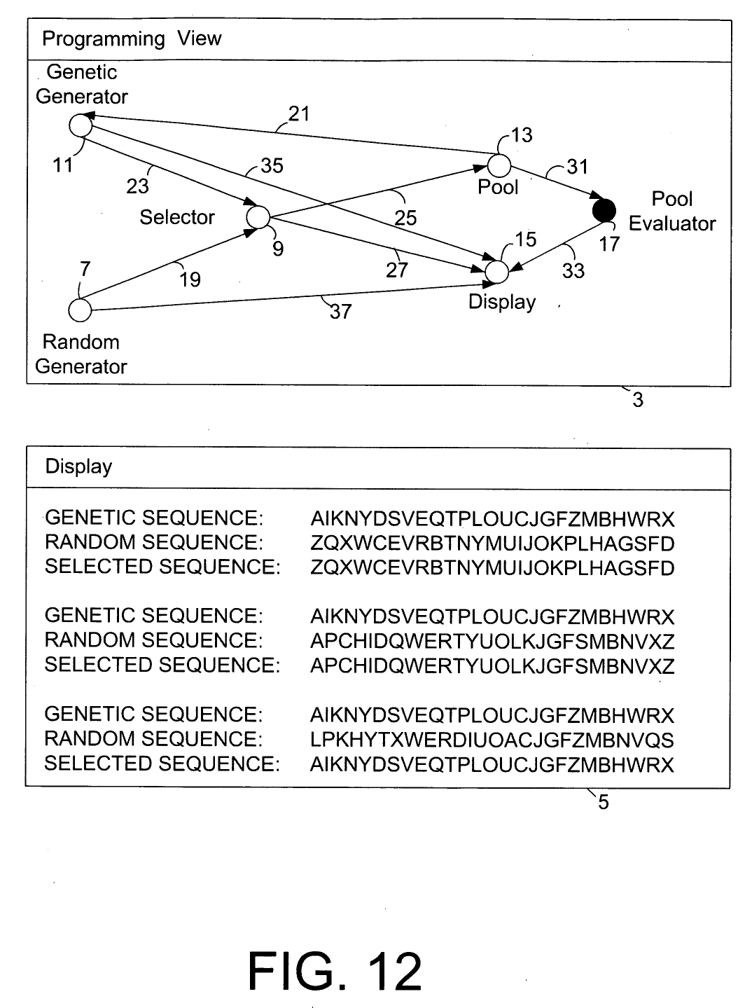

FIG. 12 illustrates the first view 3 of the data flow node-link structure representing the program, and the second view 5 of results, wherein a parent object, namely the Pool Evaluator, is disabled.

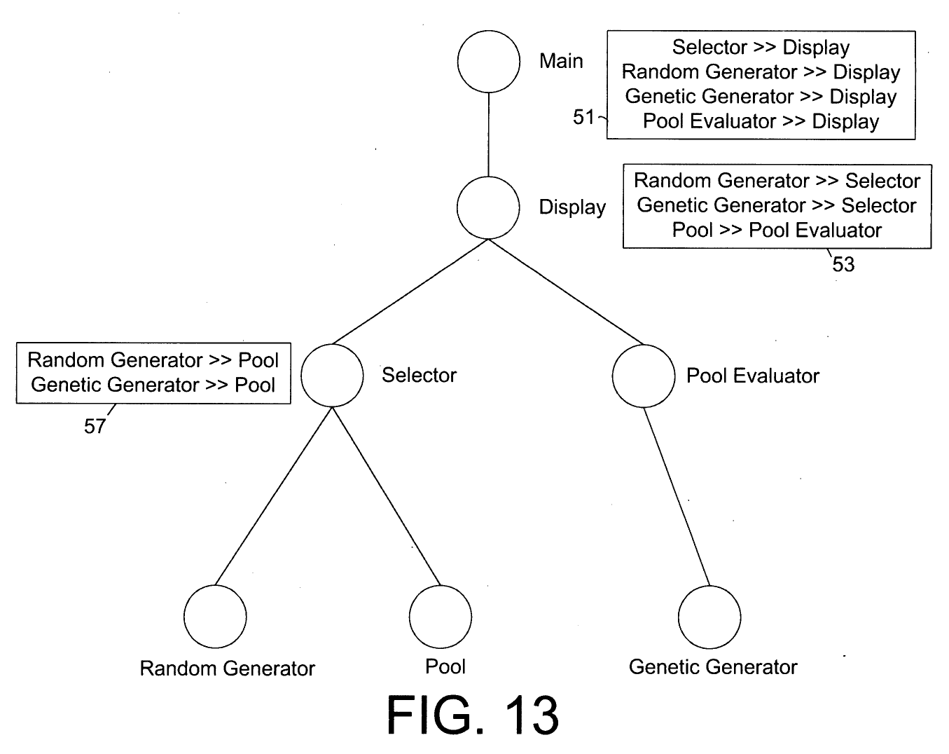

The corresponding hierarchical structure is illustrated in FIG. 13. The Main embodies a pointer to the program, and has one child, namely the Display. The latter has two children, the Selector and the Pool Evaluator. The Selector also has two children, the Random Generator and Pool, whereas the Pool Evaluator has only one child, the Genetic Generator.

As in the case where it was not a parent, the disabled Pool Evaluator is not provided with its list of data sources, nor is it executed. Furthermore, it is excluded from all lists of data sources. However, due to its hierarchical status, its disabled state has further consequences on the execution of the program.

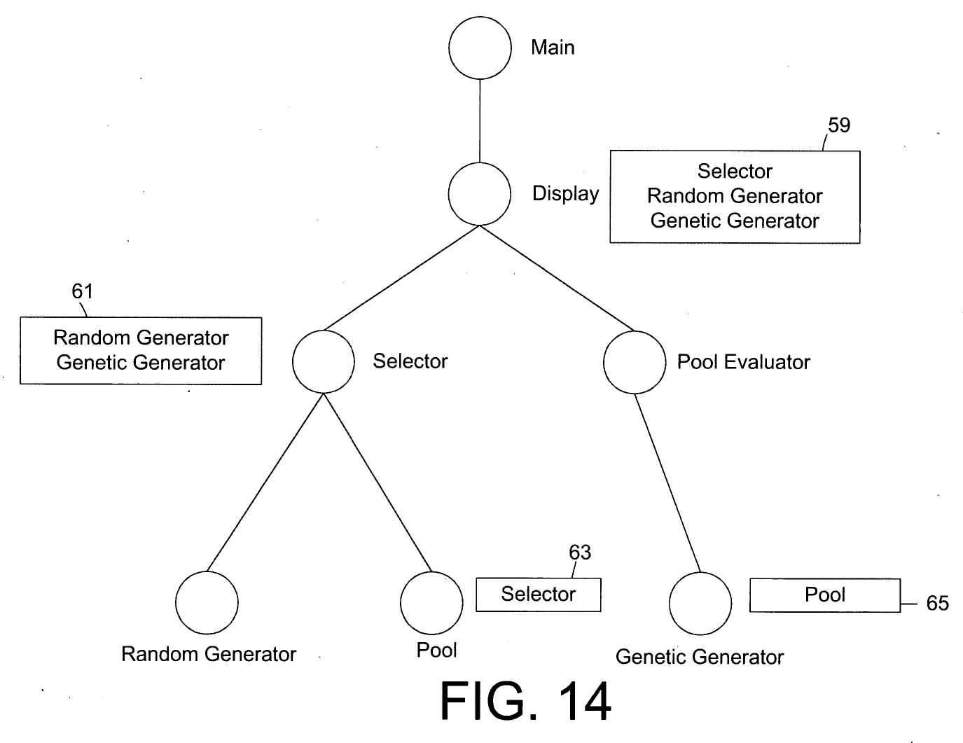

FIG. 14 illustrates the hierarchical node-link structure, as well as the lists of data sources, wherein the lists take into consideration the disabled state of the Pool Evaluator.

According to the present invention, when the Main is called, it establishes a list of data sources 59 for the Display according to its list of data flows 51. The list 59 is comprised of pointers tc, each enabled data source of the Display, namely the Selector, Random Generator, and Genetic Generator. Subsequently, the Main is informed that the Display is enabled by accessing its state flag, and consequently, calls the Display.

When the Display is called, it establishes a list of data sources 61 for the Selector according to its list of data flows 53, but not for the Pool Evaluator since the latter is disabled. The list 61 is comprised of pointers to each enabled data source of the Selector, namely the Random Generator and Genetic Generator. Subsequently, the Display calls the Selector after being informed that the latter is enabled by accessing its state flag.

When the Selector is called, it establishes a list of data sources 63 for the Pool according to its list of data flows 57. The list 63 is comprised of a pointer to the data source of the Pool, namely the Selector. Subsequently, the Selector calls the Random Generator after being informed that the latter is enabled by accessing its state flag. It is important to note that the Selector does not need to establish a list of data sources for the Random Generator since the latter is not comprised in its list of data flows 57 as a receiving object.

The Random Generator does not have any children, and therefore, does not need to establish lists of data sources. Furthermore, it is not provided with a list of data sources, and therefore, does not need to retrieve data from other objects in order to perform its tasks. As a result, when the Random Generator is called, it simply executes itself. Subsequently, the Selector calls its other child, the Pool, after being informed that the latter is enabled by accessing its state flag.

The Pool does not have any children, and therefore, does not need to establish lists of data sources. It processes its list 63 in order to retrieve a selected sequence of letters from the Selector. The Pool is informed that the Selector has been called by accessing its call flag, and consequently, it retrieves the selected sequence of letters and performs its main task.

Subsequently, the Selector resumes its execution since the Random Generator and Pool have both been executed. The Selector processes its list of data sources 61 in order to retrieve the sequences of letters generated by the Random Generator and Genetic Generator. The Selector is informed that the Random Generator has been called by accessing its call flag and consequently, it retrieves the randomly generated sequence. Thereafter, it is informed that the Genetic Generator has not yet been called by accessing its call flag. As a result, it calls the Genetic Generator. The latter is informed that the Pool Evaluator is disabled by accessing its state flag. Consequently, the Selector retrieves from the Genetic Generator a sequence genetically generated in a previous cycle, attributes a score to each retrieved sequence, and selects the one with the highest score.

Since the Selector has been executed, and the Pool Evaluator is disabled, the Display resumes its own execution by processing its list of data sources 59, verifying that the Selector, Genetic Generator, and Random Generator have been called by accessing their call flags, retrieving the selected sequence from the Selector, as well as the generated sequences from the Random Generator and Genetic Generator, and displaying the retrieved data within the view 5.

Referring back to FIG. 12, the consequences of the disabled state of the Pool Evaluator are shown within the view 5. As in the previous case, where the Pool Evaluator was not a parent, the average score of the sequences stored in the Pool is not displayed. However, in this case, since the Genetic Generator is not executed, the same genetic sequence is repeatedly provided to the Display, and presented within the view 5 after each execution of the program.

In another embodiment, programming objects refer to a list in order to be informed of a state of another object, wherein the list comprises a state of each programming object.

Object-oriented computer programming provides means for executing a program from a state achieved as a result of its last execution. Consequently, evolving programs may be designed wherein an evolution is achieved through repeated execution. For instance, in the case of the program described herein above, its state may be defined as the content of the Pool and each execution refines a previously established content.

In the following description, the term “cycle” shall be taken to designate an execution of an object-oriented computer program. As such, a “second cycle” refers to a second execution of the program from a state achieved as a result of a first execution. The term “cyclical execution” shall be taken to designate a repeated execution of the program.

The process of testing an evolving program usually involves monitoring values of variables during its cyclical execution in order to determine whether they meet expectations. When an inconsistency is located, programmers typically modify parameters of the program, initiate a new cyclical execution process from its initial state, wait until a cycle during which the inconsistency was located is attained, and monitor an effect of their modifications on the inconsistent variable in order to determine a corresponding cause. As a result, the debugging process becomes extremely time-consuming, especially when an inconsistency appears in an advanced cycle, in which case programmers are required to repeatedly execute the program until the advanced cycle is attained.

The present invention provides means for reducing the duration of the debugging process, whereby programmers may retrieve an intermediate state of the program achieved as a result of an advanced cycle, and initiate a cyclical execution process from the retrieved state.

According to a preferred embodiment of the present invention, a programmer is provided with a state line controller and a state view displayed on a computer screen. The state line controller provides means for controlling a cyclical execution process of a program being tested. The state view, on the other hand, provides means for selecting variables of the program as state variables, and monitoring values of those variables during the process.

A method of utilizing the state line controller and the state view is described in the context of debugging the program presented herein above, wherein a frequency with which genetic operations are performed is defined by the programmer. More specifically, a frequency with which crossbreeding operations are performed corresponds to a user-defined “Crossbreeding. Level”, and that with which mutations are performed, to a user-defined “Mutation Level”. Furthermore, all sequences of letters of the Pool are stored in a variable labelled “Pool Content”, and their average score, in a variable labelled “Pool Score”.

In the preferred embodiment, once the program is created, it is searched for declarations of variables, and pointers to located variables are incorporated in a list. The latter is presented within the state view in order for the programmer to specify which variables are to be considered state variables, and which of those state variables he wishes to monitor. In another embodiment, all variables of a program are automatically considered state variables.

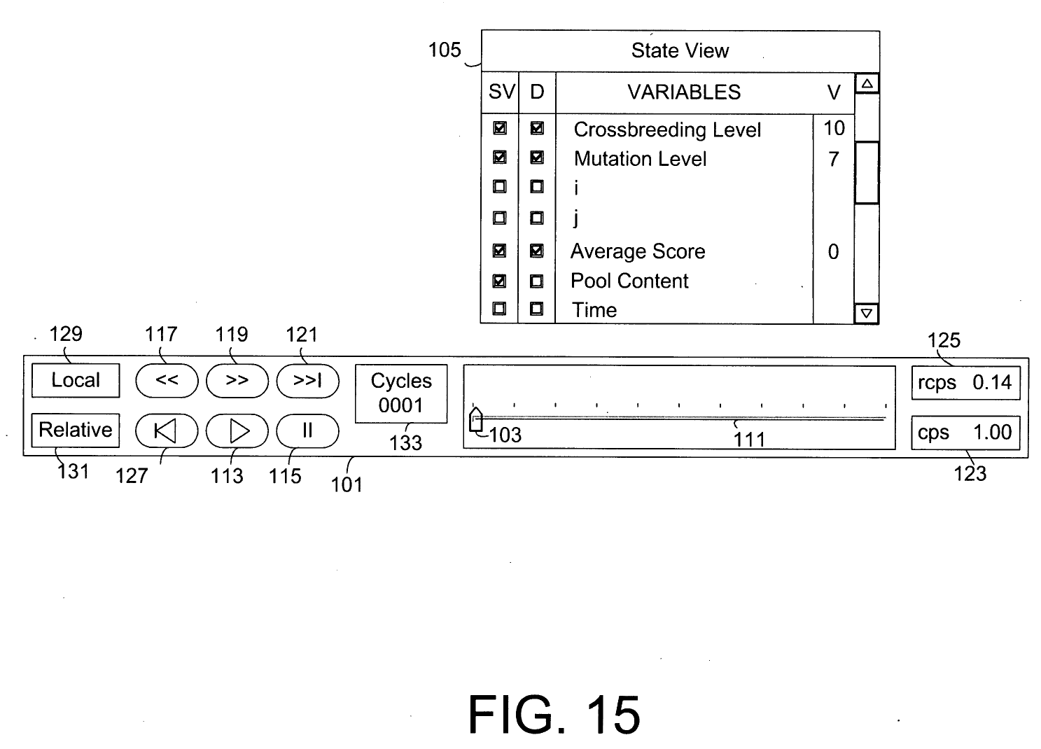

FIG. 15 illustrates a state line controller 101 comprising a slider 103 indicating that a program is starting its initial cycle, and a state view 105 presenting initial values of selected state variables.

The programmer checked squares of a column presented within the view 5 and labelled “SV”, corresponding to the variables “Crossbreeding Level”, “Mutation Level”, “Pool Content”, and “Pool Score” in order for the latter to be identified as state variables. Furthermore, he checked squares of another column presented within the view 5, and labelled “D”, corresponding to the “Crossbreeding Level”, “Mutation Level”, and “Pool Score” in order to be provided with values of the latter.

The controller 101 presents a state line 111 comprising eleven graduations, or reference points, wherein each graduation refers to a cycle of the program. The slider 103 is positioned under a first graduation as to indicate that the program is at the beginning of a first cycle.

It is important to note that graduations represent relative indicators. A 10^{th} graduation refers to a 10^{th} cycle of the program if the 1^{st} graduation refers to a 1^{st} cycle, but may refer to a 14^{th} if the 1^{st} graduation refers to a 4^{th}. In order to remove any ambiguity, a cycle counter 133 is displayed within the controller 101, indicating a cycle designated by a graduation under which the slider 103 is displayed.

The controller 101 also comprises eight main control buttons. A Play button 113 allows a programmer to initiate a cyclical execution process of the program. The process is sustained until interrupted by the program itself, or the programmer.

One of the most convenient ways of interrupting a cyclical execution process consists in clicking on a Pause button 115, in which case the process halts after an execution of a current cycle is completed.

The controller also comprises a Rewind button 117, and a Forward button 119, whereby a user may retrieve previously encountered states of the program. When the button 117 is clicked, the slider 103 moves back to a previous graduation, and a corresponding previous state is retrieved. On the other hand, when the button 119 is clicked, the slider 103 moves forward to a subsequent graduation, and a corresponding state is retrieved. When one of the buttons 117 and 119 is clicked and held down, the motion of the slider 103 and retrieval of the corresponding states is continuous.

The Rewind button 117 is particularly useful when used in combination with the Pause button 115 during a process. If the programmer encounters an inconsistency during a current cycle, he may click the Pause button 115 to interrupt the process, click the Rewind button 117 to review previous state variable values within the state view 105, and click on the Pause button 115 to continue the process from the cycle at which it was interrupted.

A program may have a short execution time, and as a result, cycles may succeed each other at a very high rate during a process, leaving programmers with very little time to absorb information presented within the state view 105. In such cases, the programmer may use a Step button 121 to execute a single cycle. The programmer may alternatively choose to lower the rate at which cycles are executed by entering a desired number of cycles per second in a CPS view 123. In the case where the programmer enters a number of cycles per second that exceeds the capabilities of the computer system on which the program is running, an actual number of cycles per second may diverge from the desired one. Consequently, a real number of cycles per second is presented in a RCPS view 125.

Finally, a Reset button 127 allows a user to reset the counter 133 to zero, whereby the slider 103 is moved back to the first graduation, and an initial state of the program is retrieved. Other control buttons associated with more sophisticated functionalities are presented herein below.

In another embodiment, the state line controller comprises a cycle counter indicating a current cycle of a current process, a cyclical edition box, in which the user may specify a cycle of interest, and a Play button, through which a user may initiate a cyclical execution process from a state stored as associated to a cycle of interest specified in the cyclical edition box.

During an initiated cyclical execution process, the slider 103 moves along the state line 111 to designate a current cycle of the program, and the view 105 presents corresponding values of selected state variables. At the end of each cycle, values of all state variables of the program are stored in memory as associated to a corresponding cycle. In the preferred embodiment, if a specific cycle is executed more than once, only values of state variables obtained as a result of a last execution of the cycle are kept in memory. When the memory reserved for storing encountered states of a program become saturated, the oldest states are deleted in order to make place for the new ones. In another embodiment, one encountered state is stored every nth cycle, wherein n is specified by the user.

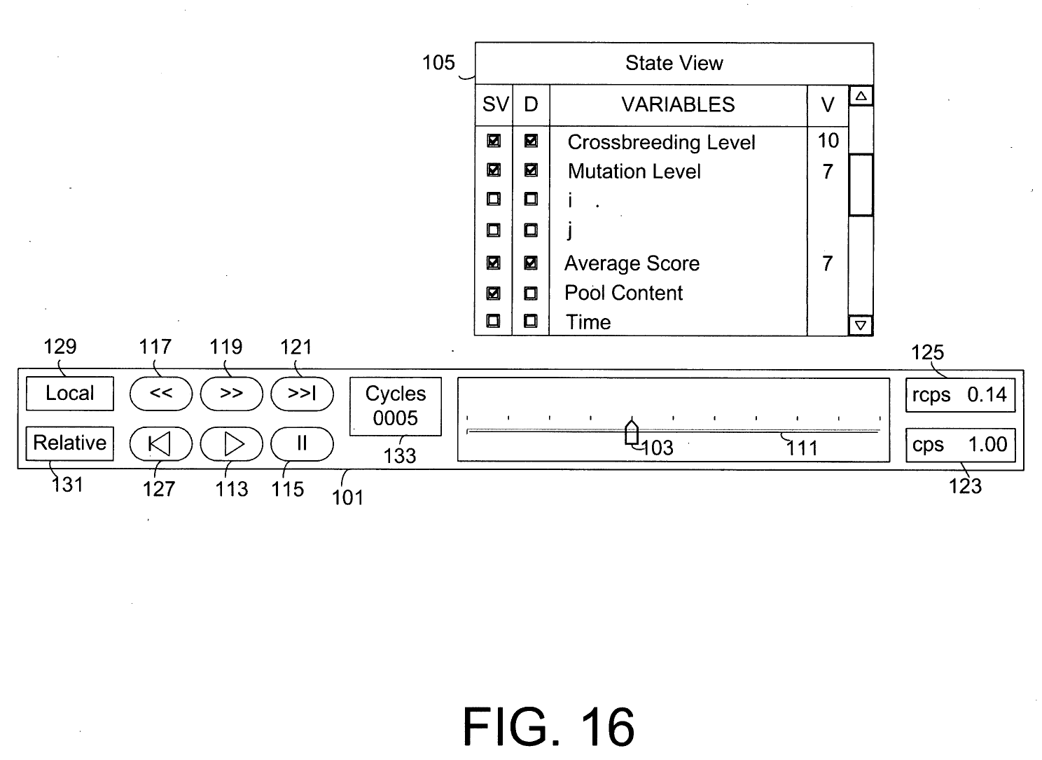

FIG. 16 illustrates the state line controller 101 and the state view 105, wherein the values of the state variables result from a 4^{th} executed cycle, and the counter 133 indicates that the program is starting a 5^{th} cycle.

According to information provided within the state view 105, the Crossbreeding Level and Mutation Level have maintained their values, while the Average Score has increased from 0 to 7 after four execution cycles. Those values are stored in memory along with that of the Pool Content as associated to the 4^{th} executed cycle.

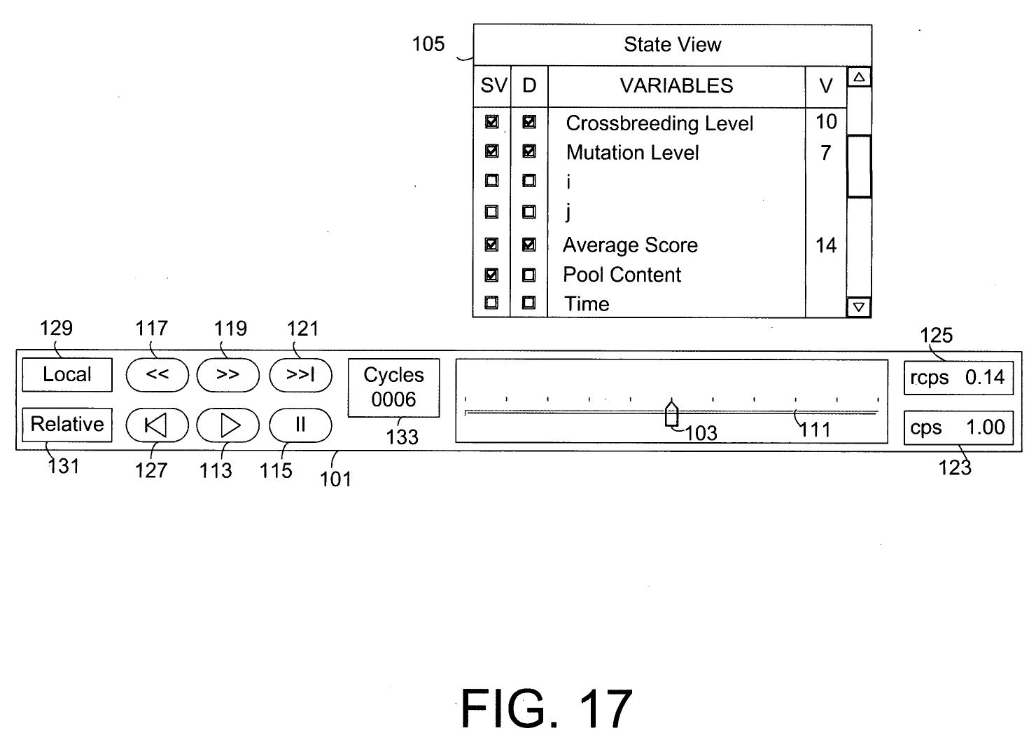

FIG. 17 illustrates the state line controller 101 and the state view 105, wherein the values of the selected state variables result from a 5^{th} executed cycle, and the counter 133 indicates that the program is starting a 6^{th} cycle.

According to information provided within the state view 105, the Crossbreeding Level and Mutation Level have maintained their values, while the Average Score has increased from 7 to 14 following the fifth cycle. Those values are stored in memory along with that of the Pool Content as associated to the 5^{th} executed cycle.

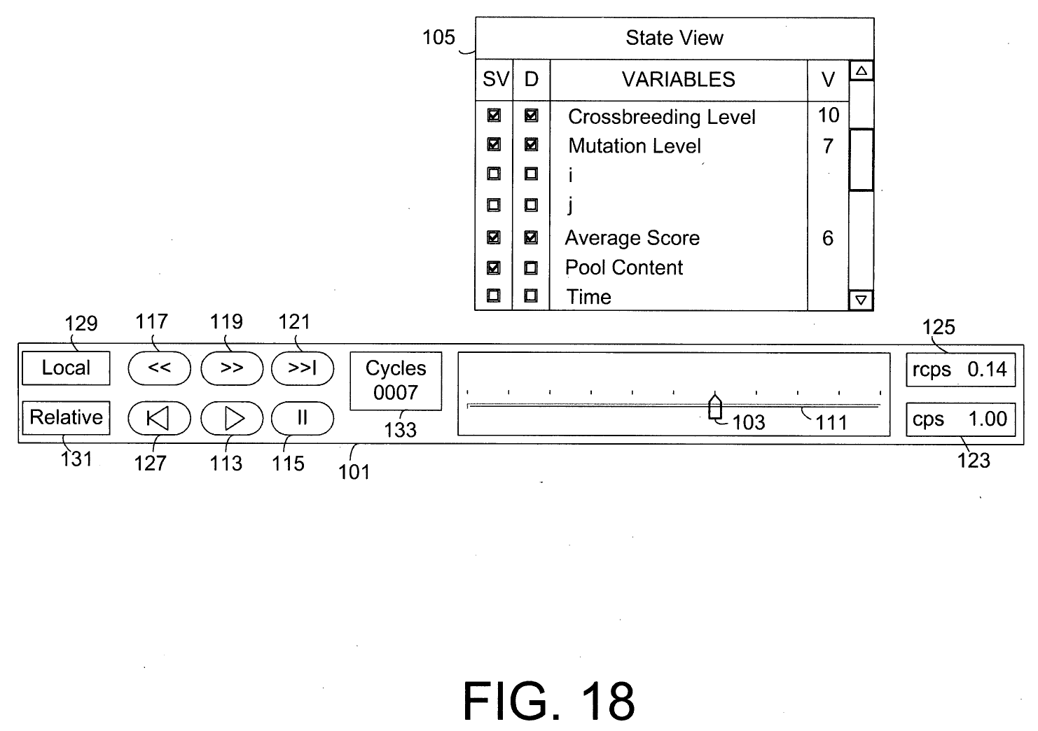

FIG. 18 illustrates the state line controller 101 and the state view 105, wherein the values of the state variables result from a 6^{th} executed cycle, and the counter 133 indicates that the program is starting a 7^{th} cycle.

According to information provided within the state view 105, the Crossbreeding Level and Mutation Level have maintained their values, while the Average Score has decreased from 14 to 6 following the sixth cycle. Those values are stored in memory along with that of the Pool Content as associated to the 6^{th} executed cycle.

In the case illustrated in FIGS. 15-18, the programmer noticed by monitoring information provided within the state view 105 an increase of the Average Score between the 1^{st} and 5^{th} cycles and a decrease thereafter, although a continuous increase is expected throughout the cyclical execution process. Consequently, he decided to adjust parameters of the genetic operators in an attempt to maintain an increase of the Average Score beyond the 5^{th} cycle.

Prior art methods for performing and evaluating such adjustments consist in modifying an initial state of the program and initiating a cyclical execution process from the modified initial state. However, according to the present invention, the programmer may move the slider 103 along the state line 111 such that it designates a cycle of interest, whereby values of state variables corresponding to the cycle of interest are retrieved. Furthermore, those of the retrieved values that are associated with selected state variables are displayed within the state view 105. The programmer may thereafter modify state variable values within the state view 105 to create a modified version of the state associated to the cycle of interest, and initiate a cyclical execution process from the modified state.

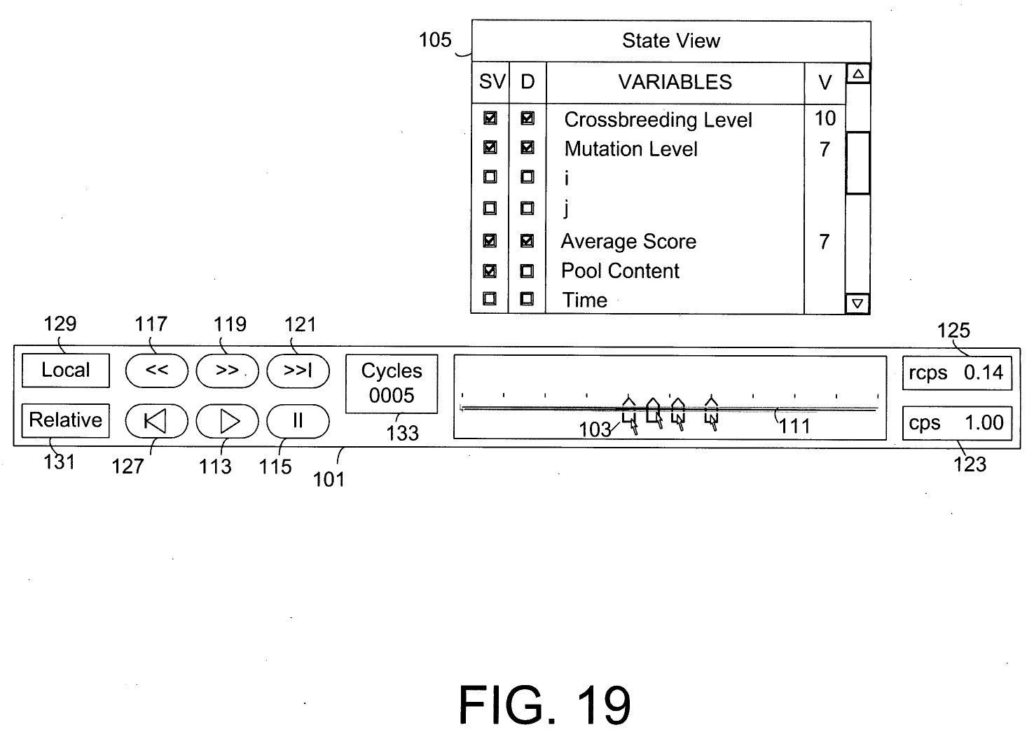

FIG. 19 illustrates the state line controller 101 and the state view 105, wherein the slider 103 is moved from a graduation designating a 7^{th} cycle to another designating a 5^{th}, and the values of the state variables correspond to a last 5^{th} cycle executed.

The programmer moved the slider 103 along the state line 111 such that it designates the 5^{th} cycle and consequently, values of selected state variables associated to the 5^{th} cycle are retrieved. Those of the retrieved values corresponding to the selected state variables, namely the Crossbreeding Level, Mutation Level, and Average Score, are displayed within the state view 105.

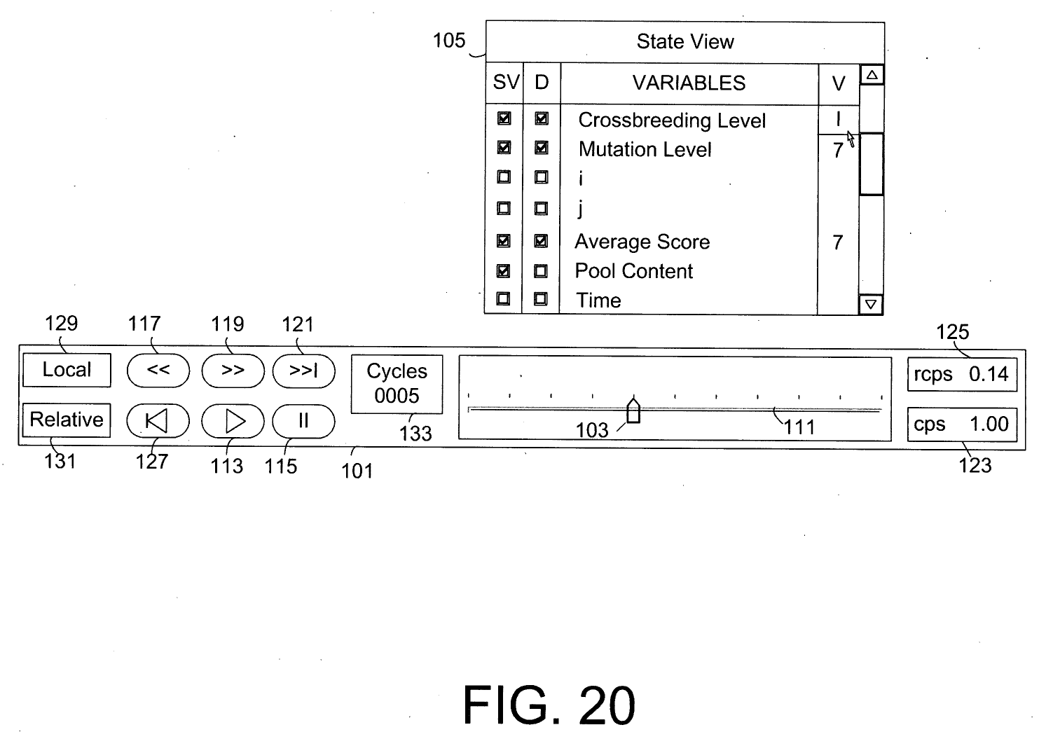

FIG. 20 illustrates the state line controller 101 and the state view 105, wherein a value of one of the state variables is specified as resulting from a 4^{th} cycle executed.

In order to maintain an increase of the Average Score beyond the 5^{th} cycle, the programmer modified the retrieved value of the Crossbreeding Level, and initiated a new cyclical execution process from a state defined by the retrieved values of the Mutation Level, Pool Content, and Average Score, and the modified value of the Crossbreeding Level.

It is important to note that prior art methods would have required that the first four cycles be executed prior to executing subsequent ones, which would have been time-consuming. Furthermore, an effect of a modification would not have been isolated, since the second execution of the 5^{th} cycle would have been performed from a state achieved as a result of a second execution of the first four cycles, instead of that achieved as a result of the first execution. In the case of the program described herein above, the two executions of the 5^{th} cycles would not have been based on a same content of the Pool, since the second execution of the first four cycles would have very likely resulted in a Pool different from the one that resulted from their first execution

In the preferred embodiment, a value of a state variable presented within the state view 105 may be modified by having the programmer select the value with a mouse pointer, and enter a desired value.

Still in the preferred embodiment, the state line controller comprises a Scope button 129 and a Relativity button 131 for the purpose of facilitating an edition of values displayed within the state view 105. The Scope button 129 has two states, namely “Local” and “Global”. Similarly, the Relativity button 131 has two states, namely “Relative” and “Absolute”. The user may toggle between the states of either one of the buttons 129 and 131, through a mouse pointer.

When the Scope button 129 is set to “Local”, and the Relativity button 131 is set to “Absolute”, a value entered by the programmer is assigned to a corresponding state variable, within a corresponding cycle. However, if the Relativity button 131 is set to “Relative”, a value and an operator entered by the programmer are applied to a value of a corresponding state variable within a corresponding cycle.

When the Scope button 129 is set to “Global”, and the Relativity button 131 is set to “Absolute”, a value entered by a user is assigned to a corresponding state variable, within all cycles. However, if the Relativity button 131 is set to “Relative”, a value and an operator entered by a programmer are applied to a value of a corresponding state variable, within all cycles.

According to the present invention, the programmer may move the slider 103 along the state line 111 such that it refers to a new cycle that has never been executed before, and as such, is not associated with state variable values. In such a case, state variable values associated to a most advanced executed cycle preceding the new cycle are retrieved, and stored as associated to the new cycle as well. Those of the retrieved values associated with selected state variables are displayed within the state view 105. The programmer may thereafter click on the Play button 113 to initiate a cyclical execution process from the state associated to the new cycle.

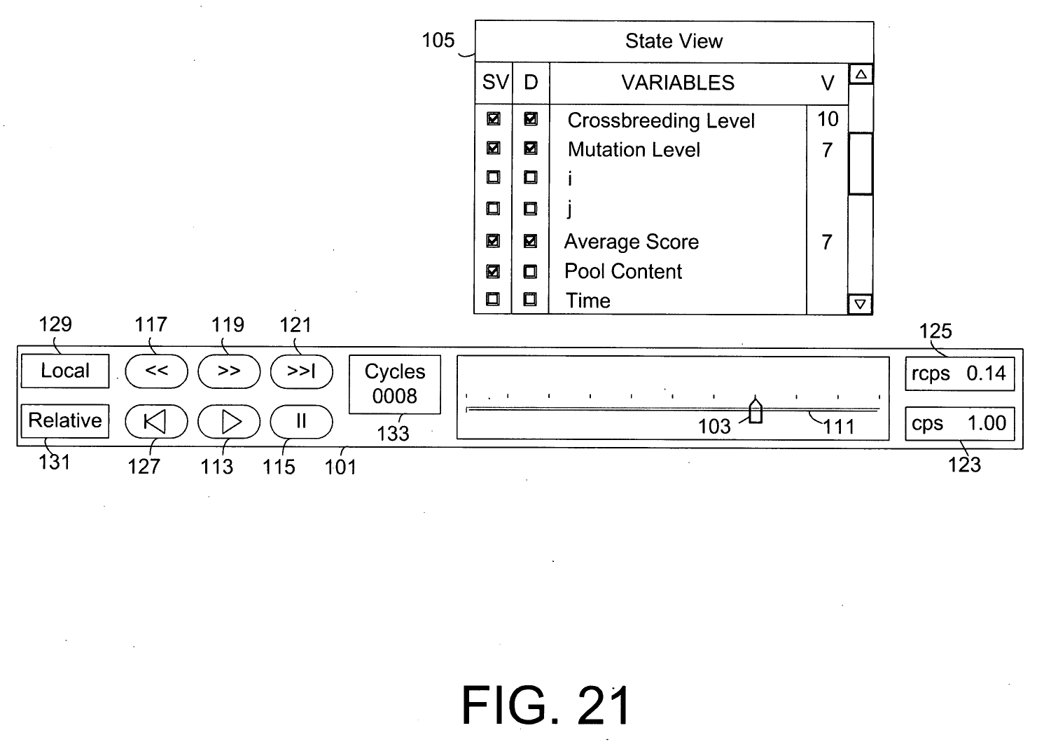

FIG. 21 illustrates the state line controller 101 and the state view 105, wherein the slider 103 is positioned by the programmer such that it refers to an 8^{th} cycle, and default values are assigned to the state variables since the 7^{th} cycle has never been completely executed.

The programmer moved the slider 103 along the state line 111 such that it designates a cycle that has not been previously executed before, namely a 7^{th} cycle, and as such, is not associated to state variable values stored in memory. As a result, the state variable values associated to the 6^{th} cycle, which is the most advanced cycle preceding the 7^{th} among those that were executed, are associated to the 7^{th} cycle as well.

A comparison of FIGS. 18 and 21 clearly shows that the information presented in the state view 105 is identical although the counter 133 refers to different cycles.

Although in the cases described herein above, the slider 103 is moved along the state line 111 to a specific graduation, it may very well be moved to a position located between two graduations. In such a scenario, if the two bounding graduations designate cycles that were previously executed, the intermediate position of the slider 103 is associated to values of state variables obtained through an interpolation of values associated to the cycles corresponding to the bounding graduations. In one embodiment, interpolations are performed linearly. However, in the preferred embodiment, the programmer may specify the type of interpolation used for calculating values of state variables to be associated with intermediate positions of the slider 103.

However, not all state variables may be obtained through interpolation. For instance, variables of type Boolean may only be assigned one of two values, True or False, and an interpolation between the latter values would result in neither True nor False. In such cases, the state variable is assigned a value associated to a cycle preceding the one designated by a closest bounding graduation to the slider 103. In another embodiment, the state variable is assigned a value associated to a cycle preceding an earliest one of two cycles designated by bounding graduations.

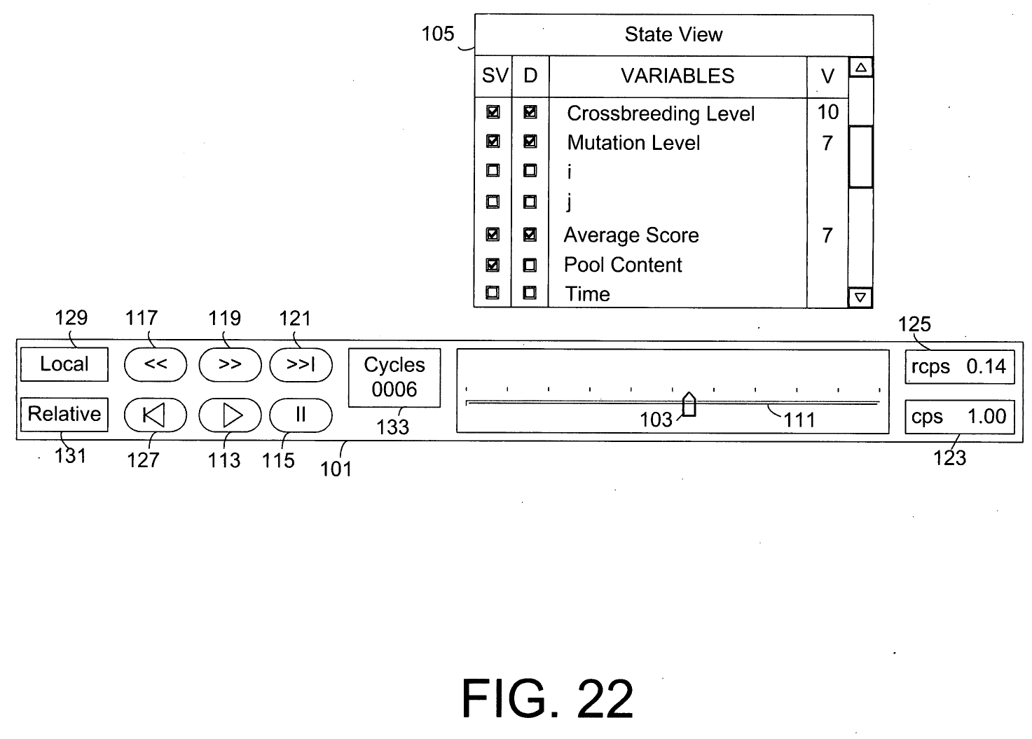

FIG. 22 illustrates the state line controller 101 and the state view 105, wherein the slider 103 is positioned between graduations referring to the 6^{th} and 7^{th} cycle, and the values of the state variables are obtained through interpolation.

The programmer moved the slider 103 along the state line 111 to an intermediate position located between graduations referring to the 6^{th} and 7^{th} cycles. Since both cycles have been executed, the intermediate position is associated to values obtained through an interpolation.

The slider 103 is exactly in the middle of a segment defined by the two bounding graduations. As a result, the value of the Crossbreeding Level is equal to (10+10)/2=10, that of the Mutation Level is equal to (7+7)/2=7, and that of the Average Score, (14+6)/2=10. Once calculated those values are presented within the state view 105.

As for the Pool Content, it is assigned a content associated to a cycle preceding the one corresponding to a closest one of the two bounding graduations. In the case illustrated in FIG. 22, the slider 103 is at an equal distance from both graduations, and the Pool Content is therefore assigned a content achieved as a result of the 5^{th} cycle. However, if the slider 103 were closer to the graduation corresponding to the 7^{th} cycle, the Pool Content would have been assigned a content achieved as a result of the 6^{th} cycle.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A method of controlling an execution of an object-oriented computer program comprising a plurality of programming objects, comprising:
detecting at least one data transmission between two of said plurality of programming objects;
identifying at least one of said at least one data transmission as an invalid data transmission; and
executing at least two of said plurality of programming objects according to said detecting and said identifying, wherein said invalid data transmission is not performed.

2. The method of claim 1, wherein said identifying comprises a user specifying said invalid data transmission.

3. The method of claim 1, further comprising displaying a list of said at least one data transmission, wherein said identifying comprises a user selecting said invalid data transmission from said list.

4. The method of claim 1, further comprising identifying at least one of said plurality of programming objects as an inactive programming object, wherein said inactive programming object is not executed.

5. The method of claim 4, further comprising displaying a list of said plurality of programming objects, wherein said identifying at least one of said plurality of programming objects comprises selecting said at least one inactive programming object from said list.

6. The method of claim 4, wherein said identifying at least one of said at least one data transmission as an invalid data transmission comprises determining whether one of said at least one data transmission involves one of said at least one inactive programming object.

7. A method of executing an object-oriented computer program from a specified state, comprising:
recording a plurality of state parameter values defining a plurality of states of said program at a plurality of intervals while executing said program;
reviewing at least one of said plurality of states;
identifying one of said plurality of states as a state of interest according to said reviewing; and
executing said program from said state of interest according to a corresponding at least one of said state parameter values.

8. The method of claim 7, further comprising displaying a state line, displaying a slider, associating each of a plurality of positions on said state line to one of said plurality of states, wherein said identifying comprises moving said slider along said state line to a position of interest corresponding to said state of interest.

9. The method of claim 8, further comprising displaying a plurality of reference points on said state line, wherein each of said plurality of reference points indicates one of said plurality of positions.

10. The method of claim 9, wherein said position of interest is located between two of said plurality of reference points, and said providing a state of interest comprises interpolating two states associated with said two of said plurality of reference points.

11. The method of claim 10, further comprising specifying interpolation parameters, wherein said interpolating is performed according to said interpolation parameters.

12. The method of claim 8, further comprising moving said slider along said state line according to said executing, whereby said slider indicates a position on said state line corresponding to a current state of said program.

13. The method of claim 7, further comprising displaying at least one state parameter.

14. The method of claim 7, further comprising identifying at least one state parameter of interest, and displaying said at least one state parameter of interest.

15. The method of claim 7, further comprising specifying a state parameter value of interest, and interrupting said executing said program from said state of interest when said value of interest is obtained.

16. The method of claim 7, wherein said identifying comprises specifying one of said plurality of intervals corresponding to said state of interest.

17. A computer program product for controlling an execution of an object-oriented computer program comprising a plurality of programming objects comprising a computer usable storage medium having computer readable program code means embodied in the medium, the computer readable program code means comprising:
computer readable program code means for detecting at least one data transmission between two of said plurality of programming objects;
computer readable program code means for identifying one of said at least one data transmission as an invalid data transmission; and
computer readable program code means for executing at least two of said plurality of programming objects according to said detecting and said identifying, wherein said invalid data transmission is not performed.

18. A computer program product for executing an object-oriented computer program from a specified state comprising a computer usable storage medium having computer readable program code means embodied in the medium, the computer readable program code means comprising:
computer readable program code means for recording a plurality of state parameter values defining a plurality of states of said program at a plurality of intervals while executing said program;
computer readable program code means for recording a plurality of states of said program at a plurality of intervals during said executing, wherein each of said plurality of states is defined by a plurality of state parameter values;
computer readable code means for reviewing at least one of said plurality of states;
computer readable program code means for identifying one of said plurality of state intervals as a state of interest; and
computer readable program code means for executing said program from said state of interest according to a corresponding at least one of said state parameter values.
